(19) United States
(12) Patent Application Publication
(10) Pub. No.: US 2012/0098743 A1
(43) Pub. Date: Apr. 26, 2012

(54) INPUT METHOD, INPUT DEVICE, AND COMPUTER SYSTEM

(76) Inventors: Pei-Ling Lai, New Taipei City (TW); Yang-Peng Chen, New Taipei City (TW); Hung-Yang Hsu, New Taipei City (TW)

(21) Appl. No.: 13/280,345

(22) Filed: Oct. 25, 2011

(30) Foreign Application Priority Data
Oct. 26, 2010 (TW) 099136517

(51) Int. Cl. G06F 3/033; G06F 3/02

(52) U.S. Cl. 345/157; 345/168

(57) ABSTRACT

An input method for a software keyboard is disclosed. The input method includes dividing the software keyboard into a plurality of character areas and displaying the software keyboard, generating a first touch signal, generating a first touch operation signal according to the first touch signal, selecting a first character area from the plurality of character areas according to the first touch operation signal, generating a second touch signal, generating a second operation signal according to the second touch signal, selecting a target character key from the first character area according to the second touch operation signal, and transmitting a character control signal corresponding to the target character key to a host for an input of the software keyboard.

### BACKGROUND OF THE INVENTION

1. Field of the Invention

The present invention relates to an input device, a computer system and a method of use thereof. Particularly to an input device, a computer system and a method capable of combining the advantages of touch input devices and software keyboards.

2. Description of the Prior Art

With the progression of information technology, people are more closely connected to electronic products. People frequently use electronic products with computer systems, such as notebooks, personal computers, whether they are at home or at work. A keyboard is an important input device for the computer system. For example, both a physical keyboard (such as a wired keyboard or a wireless keyboard) and a software keyboard (also called a virtual keyboard) are commonly used to input characters, numerals or commands.

Compared with the physical keyboard, the software keyboard can offer the same input functions without an additional physical device, which conserves hardware space and reduces manufacturing cost. Also, as the electronic products become smaller and lighter, the software keyboard will play an important role in next generation electronic products.

In general, in operation of the software keyboard, a user is able to utilize a cursor to select a character key on a computer screen for inputting a character, a numeral or a command when the user has an input requirement. However, some limitations and shortages are associated with the software keyboard. For example, the moving control operation of the cursor often requires operating time and accurate operation by the user. If the cursor is at the leftmost side of the software keyboard, and the next character key the user desires to select is located on the rightmost side of the software keyboard, the user needs to control the cursor to move from the leftmost side to the rightmost side, consuming operating time. In other words, when only using a single cursor to select the character key of the software keyboard, the user must exhaust significant operating time and effort to perform the moving control operation with the cursor.

On the other hand, touch control devices have become a common human machine interface in recent years. The touch control device can generate electronic signals corresponding to sensed or detected actions or gestures of the user, and can further control a cursor accordingly to provide selection functionality. In other words, the touch control device is suitable as a cursor-type input device with its simple and intuitive operation features.

Therefore, development of techniques that better utilize the touch control device with its simple operation and the software keyboard to provide faster and more user-friendly input operation should be a focus in progressive system design.

### SUMMARY OF THE INVENTION

It is therefore an objective of the present invention to provide an input device, a computer system and a method of use thereof.

The present invention disclosed an input method for a software keyboard, the input method includes dividing the software keyboard into a plurality of character areas and displaying the software keyboard; generating a first touch signal; generating a first touch operation signal according to the first touch signal; selecting a first character area from the plurality of character areas according to the first touch operation signal; generating a second touch signal; generating a second operation signal according to the second touch signal; selecting a target character key from the first character area according to the second touch operation signal; and transmitting a character control signal corresponding to the target character key to a host for an input of the software keyboard.

The present invention further disclosed an input method for a software keyboard, the input method includes dividing the software keyboard into a plurality of character areas and displaying the plurality of character areas of the software keyboard; controlling a plurality of cursors for performing character key selection in the plurality of character areas respectively; and transmitting a plurality of character control signals corresponding to the selected character keys respectively for an input of the software keyboard.

The present invention further disclosed an input device for a software keyboard, the input device includes a plurality of touch input devices for generating a plurality of touch signals corresponding to user operations; and an input control device for generating a plurality of touch operation signals according to the plurality of touch signals; wherein a plurality of character control signals corresponding to the plurality of touch operation signals is utilized for an input of the software keyboard.

The present invention further disclosed a computer system which includes a display device for displaying a software keyboard, the display device comprising a host for dividing the software keyboard into a plurality of character areas; a plurality of touch input devices for generating a plurality of touch signals corresponding to user operations; and an input control device for generating a plurality of touch operation signals according to the plurality of touch signals; wherein the host selects at least one character control signal corresponding to the plurality of touch operation signals for an input of the software keyboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a procedure for the computer system according to an embodiment of the present invention.

FIG. 3 to FIG. 7 are schematic diagrams of input operation of the computer system according to an embodiment of the present invention.

FIG. 8 is a procedure for the computer system according to another embodiment of the present invention.

FIG. 9 is a schematic diagram of input operation of the computer system according to another embodiment of the present invention.

### DETAILED DESCRIPTION

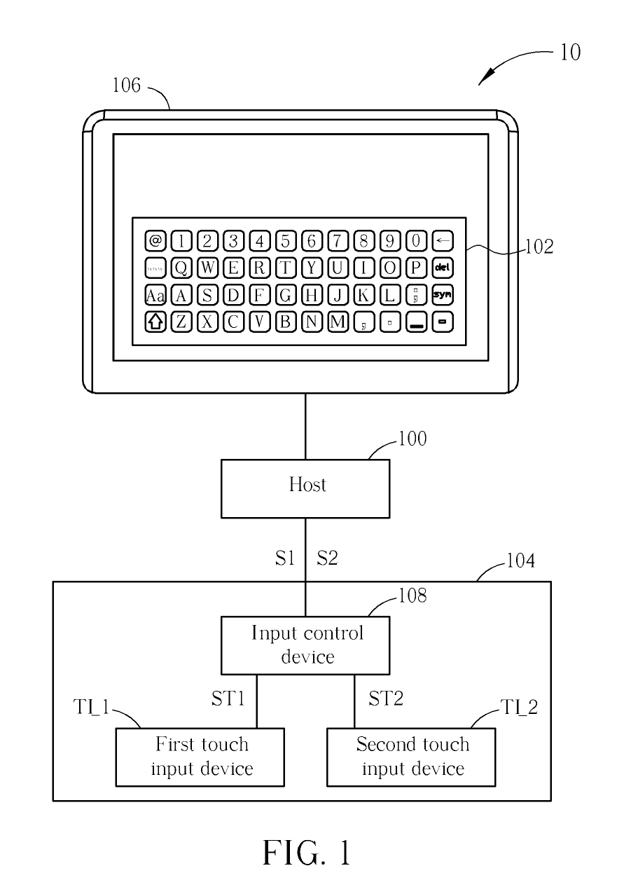

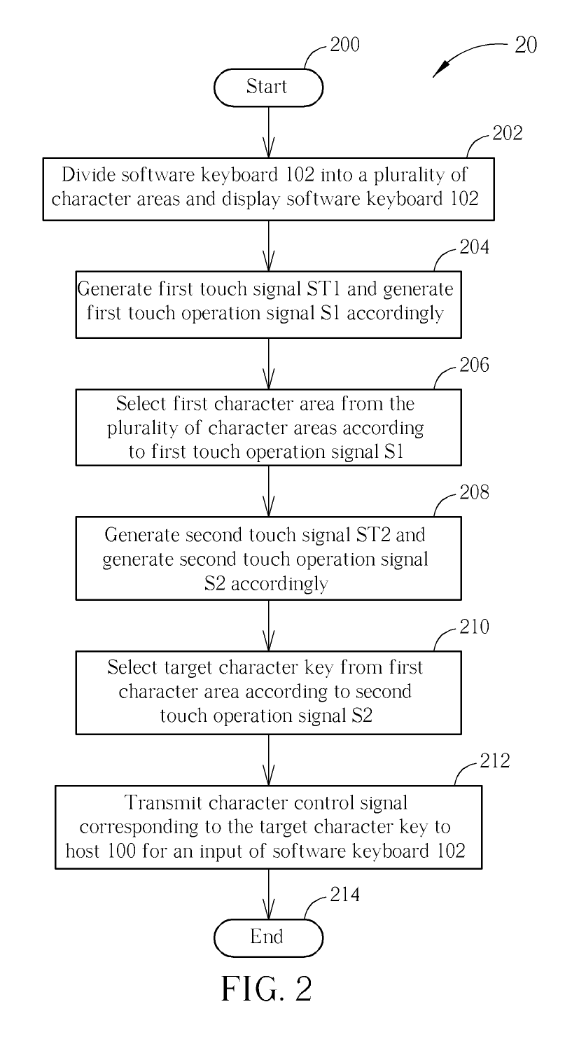

Please refer to FIG. 1 and FIG. 2. FIG. 1 is a schematic diagram of a computer system 10 according to an embodiment of the present invention. FIG. 2 is a procedure 20 for the computer system 10 according to an embodiment of the present invention. The computer system 10 includes a software keyboard 102, an input device 104, and a display device 106. The software keyboard 102 includes a plurality of character keys, and each character key corresponds to a character control signal. The display device 106 includes a host 100. The display device 106 is utilized for displaying the software keyboard 102. Whenever one of the character keys is selected, the host 100 can output one character control signal corresponding to the selected character key to a control unit (not shown in FIG. 1) of the computer system 10 for realizing the character input function. Note that, the software keyboard 102 can be any kind of software keyboard which is supplied by an application program of a computer system, and the software keyboard 102 can also include any type of key configuration and any number of character keys. For example, a standard 104-key software keyboard, a complete QWERTY software keyboard, or other specific software keyboard maybe applied in the present invention. The input device 104 includes a first touch input device TI_1, a second touch input device TI_2, and an input control device 108. When a user performs touch actions on the first touch input device TI_1, a first touch signal ST1 is generated by the first touch input device TI_1 accordingly. Similarly, when the user performs touch actions on the second touch input device TI_2, a second touch signal ST2 is generated by the second touch input device TI_2 accordingly. Moreover, the input control device 108 can generate a first touch operation signal S1 according to the first touch signal ST1 and a touch operation signal S2 according to the second touch signal ST2. In detail, the input control device 108 can calculate movement information of the corresponding cursor according to the touch signals generated by the touch input devices, on which the user takes action, and can generate and transmit a corresponding touch operation signal accordingly to the host 100. The host 100 further calculates the corresponding operation for the software keyboard 102 according to the corresponding touch operation signal, and then the corresponding operation can be displayed on the display device 106 accordingly.

Please refer to FIG. 2. One input operation of the computer system 10 may be summarized in the procedure 20 as shown in FIG. 2. Note that the following steps are not limited to being performed according to the exact sequence shown in FIG. 2 if a roughly identical result can be obtained. The procedure 20 includes, but is not limited to, the following steps:

Step 200: Start.

Step 202: Divide software keyboard 102 into a plurality of character areas and display software keyboard 102.

Step 204: Generate first touch signal ST1 and generate first touch operation signal S1 accordingly.

Step 206: Select first character area from the plurality of character areas according to first touch operation signal S1.

Step 208: Generate second touch signal ST2 and generate second touch operation signal S2 accordingly.

Step 210: Select target character key from first character area according to second touch operation signal S2.

Step 212: Transmit character control signal corresponding to the target character key to host 100 for an input of software keyboard 102.

Step 214: End.

According to the procedure 20, in Step 202, the software keyboard 102 can be displayed on the display device 106 when the user has an input requirement. The host 100 can divide all character keys of the software keyboard 102 into a plurality of character areas, and each character area includes at least one character key. After all the character areas have been arranged for the software keyboard 102, the host 100 can set one of the character areas as a start character area, and the selected start character area can be designed with emphasized display representation when the software keyboard 102 is activated or during the last operation period of the software keyboard 102. For example, the predefined start character area can be highlighted with a highlighter effect or a frame enhanced line representation during an area selection process. The start character area can be any one of the plurality of character areas or a specific character area selected during the last operation period of the software keyboard 102. For each character area, the host 100 can select one character key from the corresponding character area to act as a beginning character key of the corresponding character area. For example, the host 100 is capable of selecting a central character key in the selected character area of the plurality of character areas as the beginning character key. In such a condition, if one of the character areas is selected, position of the corresponding beginning character key in the selected character area can be set as beginning position of the corresponding cursor. Moreover, the start character area or the beginning character key can be selected when the software keyboard 102 is activated or during the last operation of the software keyboard 102, and this is not a limitation of the invention.

Furthermore, in Step 204, since the software keyboard 102 has been displayed on the display device 106, the user performs touch actions on the first touch input device TI_1 so as to generate the first touch signal ST1 accordingly. After that, the first touch signal ST1 is transmitted to the input control device 108. The input control device 108 is able to generate and transmit the first touch operation signal S1 to the host 100 according to the first touch signal ST1. In Step 206, after receiving the first touch operation signal S1, the host 100 selects the first character area from the plurality of character areas accordingly. Also, the first touch operation signal S1 corresponds to a first direction. In other words, the first touch operation signal S1 can be generated when the user touches the first touch input device TI_1 in a direction parallel to the first direction. Moreover, for the software keyboard 102, the first direction is a direction toward a neighboring character area, i.e. the first character area, from the present character area. For example, the start character area can act as an intermediate character area at first. When the user puts his finger (or uses other input tool) on the first touch input device TI_1 to slide from left to right, this means a slide-right action is performed. The host 100 can arrange the character area which is located on the right side of the start character area as the next intermediate character area according to the first touch operation signal S1. In such a situation, the intermediate character area is changed from the start character area to the character area located on the right side of the start character area. And, in such manner, when the intermediate character area is moved to the character area including the desired character key, the user can perform a double-click action on the first touch input device TI_1 or utilize another operation method to generate and transmit a character area selection signal to the host 100. Accordingly, the host 100 can select the last intermediate character area as the first character area. In short, the host 100 can sequentially change the intermediate character area according to the direction corresponding to user's action on the first touch input device TI_1.

In brief, in Step 204, the invention can utilize touch actions performed by the user on the first touch input device TI_1 to cause the input control device 108 to generate the first touch operation signal S1 accordingly. In Step 206, after receiving the first touch operation signal S1, the host 100 sequentially moves the cursor from a start character area to a character area containing a target character key, and selects the character area as the first character area according to the first touch operation signal S1. For example, as the user slides from left to right twice on the first touch input device TI_1, the first touch operation signal S1 is generated by the input control device 108 accordingly. The host 100 can shift to the right by two character area intervals from the start character area, and select the last character area stayed on as the first character area.

In addition, to offer a faster and more user- friendly operation for the user, in Step 202, the host 100 enhances the representation of the start character area to remind the user after all of the character areas have been arranged. For example, the host 100 can control the display device 106 to display all character areas of the software keyboard 102 to advise the user to take a touch operation on the first touch input device TI_1. After that, the host 100 can simply enhance the representation of the start character area to remind the user of the location of the start character area, so that the user is capable of performing touch operations for generating the corresponding touch operation signal. Moreover, when the host 100 controls the sequential movement from the start character area to the selected first character area, each of the passed character areas can be displayed with a highlight representation accordingly. Finally, after selecting the first character area, the first character area can be continuously displayed with highlight representation.

Furthermore, in Step 208, since the first character area has been selected, the user can perform touch actions on the second touch input device TI_2 so as to generate the second touch signal ST2 accordingly. And, the second touch signal ST2 can be transmitted to the input control device 108. After that, the input control device 108 generates and transmits the second touch operation signal S2 to the host 100 for further processing according to the second touch signal ST2. Preferably, the host 100 can display the beginning character key of the first character area after the first character area has been selected, and move a character selection cursor P into the beginning character key to act as an operation reference for the user. Regarding the character selection cursor P, the host 100 can display the character selection cursor P on any location when the software keyboard 102 is activated, and move the character selection cursor P into the corresponding beginning character key after the Step 206 is implemented. Furthermore, when the user takes touch actions on the second touch input device TI_2, the host 100 can move the character selection cursor P to another corresponding character key accordingly, and display the character selection cursor P. Therefore, since the first character area is chosen in Step 206, the predefined beginning character key in the first character area can be regarded as a reference point when performing a character key selection process in Step 210.

In Step 208, since the first character area has been selected, and the beginning character key in the first character area has been displayed, the user is capable of performing touch actions on the second touch input device TI_2, so that the second touch operation signal S2 is generated and transmitted to the host 100 accordingly. In Step 210, the host 100 moves the character selection cursor P to one desired character key in the first character area according to the second touch operation signal S2 and selects the desired character key as the target character key. The second touch operation signal S2 corresponds to a second direction. In other words, the second touch operation signal S2 is generated when the user touches the second touch input device TI_2 in the second direction. Moreover, for the software keyboard 102, the second direction is a direction toward a neighboring character key, i.e. the target character key, from the present character key on which the character selection cursor P is located. Thus, the host 100 can sequentially move the character selection cursor P to the desired target character key according to the direction corresponding to the user's action taken on the second touch input device TI_2. For example, when the user performs a slide-bottom-left action and a slide-down action on the second touch input device TI_2, the input control device 108 generates the corresponding second touch operation signal S2 accordingly. The host 100 can move the character selection cursor P from the beginning character key to a first character key at the bottom-left side of the beginning character key, and further move the character selection cursor P from the first character key to a second character key under the first character key according to the second touch operation signal S2. When the character selection cursor P is moved to the character key, i.e. the target character key, the user can perform a double-click action on the second touch input device TI_2 or utilize other operation method to generate and transmit a character key selection signal to the host 100. Accordingly, the host 100 can select the selected character key as the target character key. Preferably, the host 100 can sequentially display all character keys passed during the process of moving the character selection cursor P.

Finally, in Step 212, the host 100 controls transmission of the character control signal corresponding to the target character key as an input of the software keyboard 102 in order to realize a character input function.

Therefore, the user can quickly access the desired character key without driving the cursor through the large region of the software keyboard for finding the desired character key. According to the invention, the user can perform input operations by operating an input touch device in a menu selection manner. In other words, the invention combines the features of a software keyboard having various character areas, cursors capable of being operated by various touch input devices, and sliding input characteristics to allow the user to utilize touch input devices to operate the software keyboard, so as to achieve character input quickly and conveniently. In addition, through implementation of the corresponding display mannerisms during the selection process, the invention can offer a more user-friendly and intuitively operation mode for the user.

Note that, the procedure 20 is an exemplary embodiment of the invention, and those skilled in the art can make alternations and modifications accordingly. For example, the host 100 can utilize any type of highlighting or enlargement method to represent the highlighted character areas or character keys. The first touch signal ST1 or the second touch signal ST2 is a touch signal generated by performing a slide operation on the corresponding touch input device through an input tool. Preferably, the input tool can be a finger or a touch pen, and this is not a limitation of the invention. The input control device 108 can transmit the touch operation signal S1 or the touch operation signal S2 to the host 100 through wired or wireless technology. The first touch input device TI_1 and the second touch input device TI_2 can also communicate with the host 100 by wired or wireless technology. In addition, the first touch input device TI_1 and the second touch input device TI_2 can be integrated in the same device.

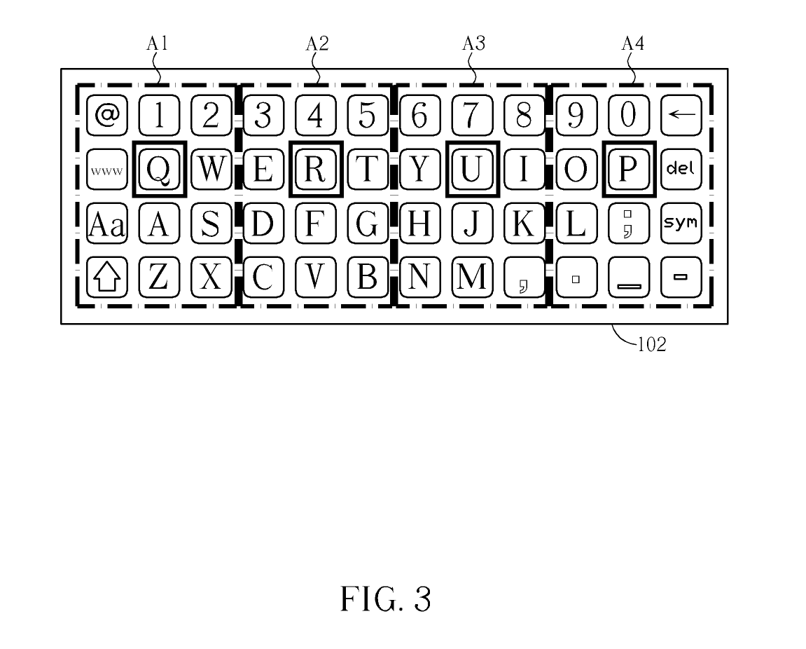

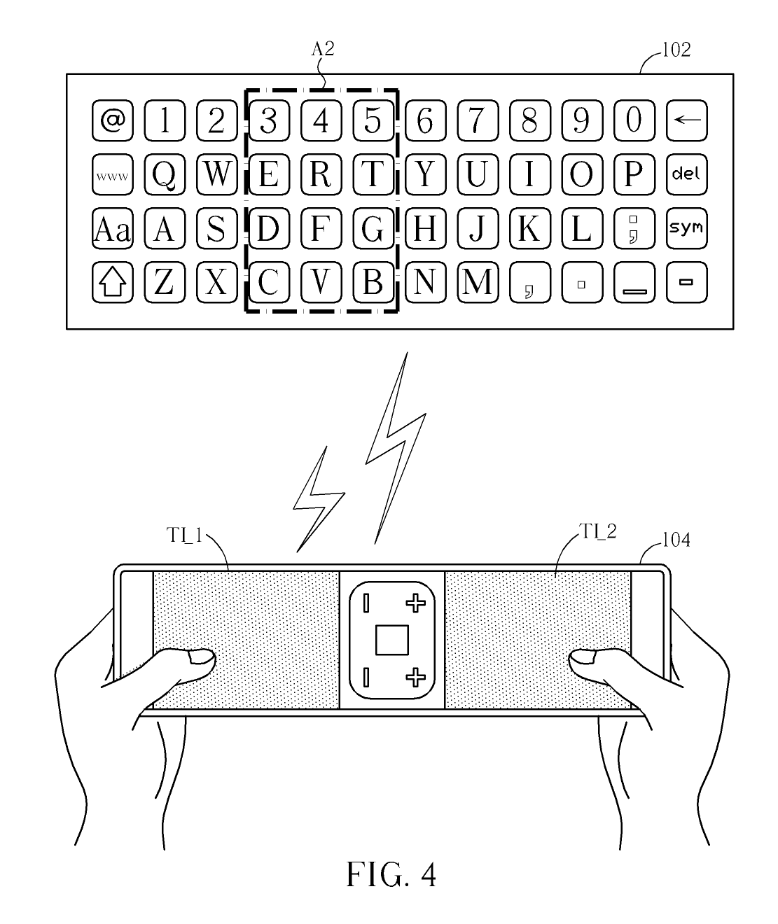

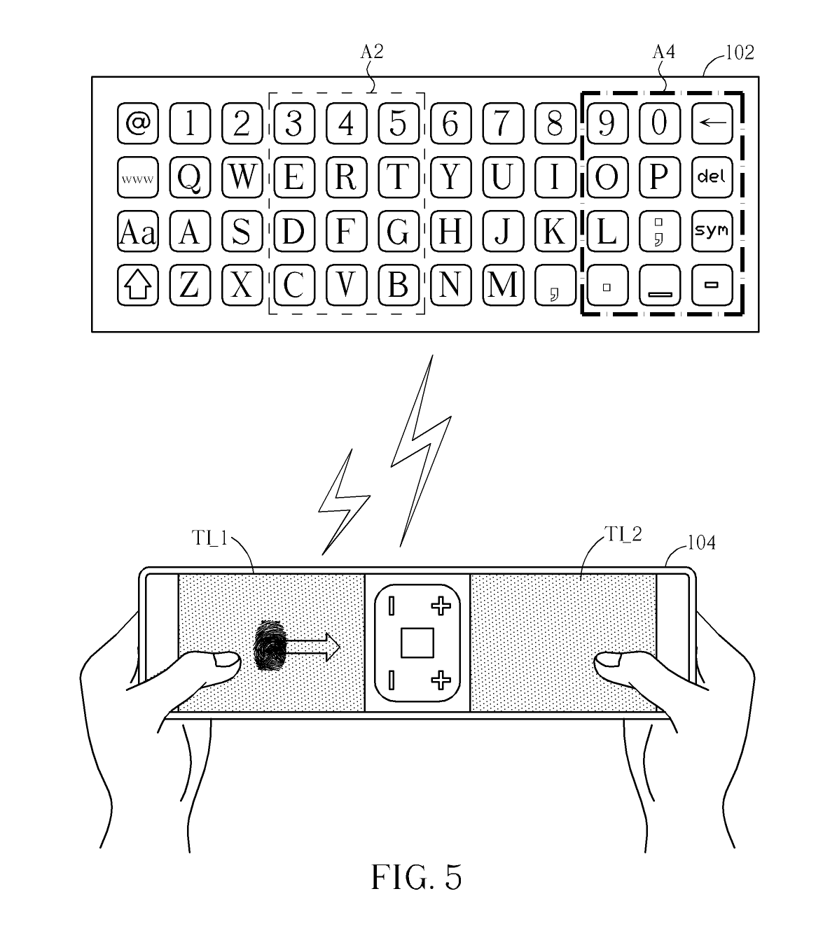

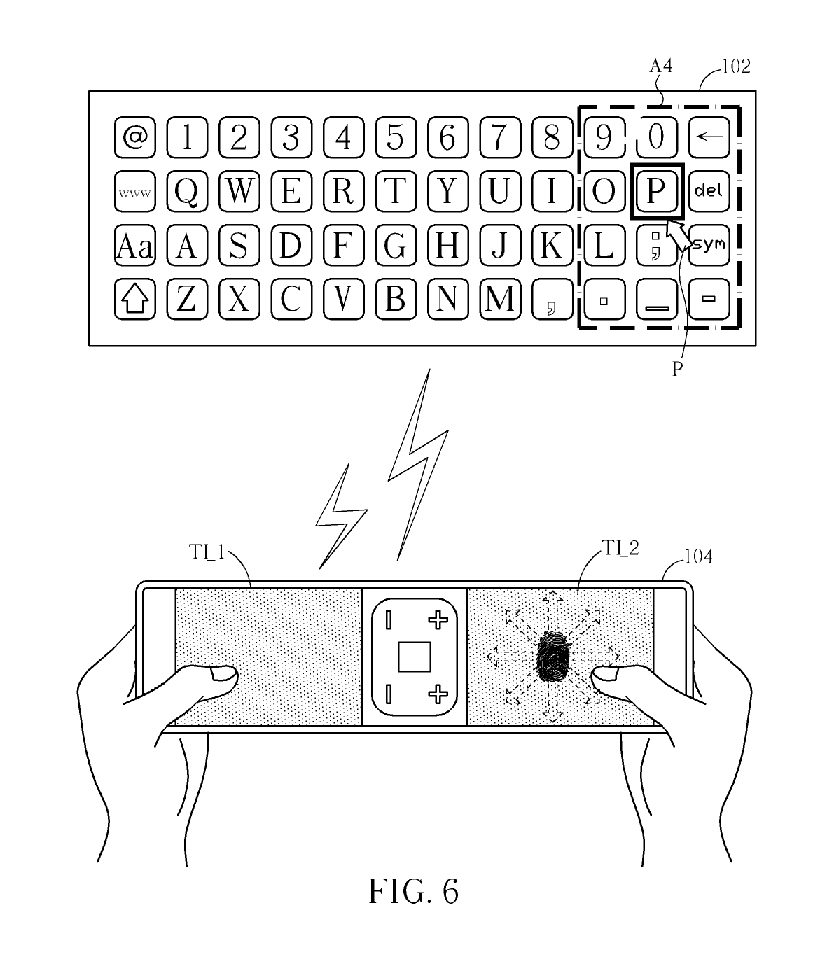

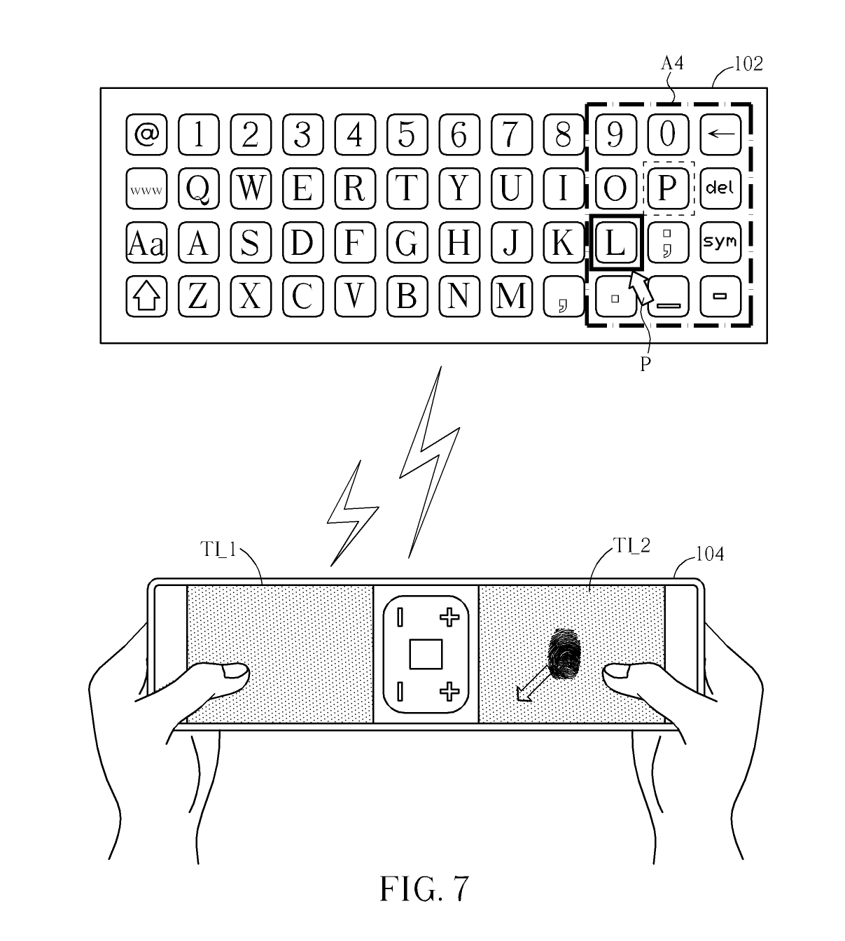

The following further elaborates an operation example of the computer system 10. Suppose the first touch input device TI_1 and second touch input device TI_2 are wireless touch controllers. When the user has an input requirement while operating an application program executed in the computer system 10, for example, if the user wants to input a character L in a text input box created by the application program, the target character key is the character key “L” of the software keyboard 102, and the software keyboard 102 has been displayed on the display device 106. In such a condition, please refer to FIG. 3. The software keyboard 102 is divided into four character areas (i.e. A1 to A4) by the host 100. The character keys “Q”, “R”, “U”, and “P” are respectively selected as beginning character keys for the corresponding character areas. As shown in FIG. 3, through the control of the host 100, the character areas A1 to A4 are displayed with highlight representation for a period of time. Furthermore, the character area “A2” is selected as the start character area by the host 100, and the character area “A2” is displayed with highlight representation successively, as shown in FIG. 4. Then, the user utilizes one finger of his/her left hand to slide from left to right twice on the first touch input device TI_1. The input control device 108 generates and transmits the corresponding first touch operation signal S1 to the host 100 accordingly. The host 100 selects the character area “A4” as the first character area according to the first touch operation signal S1. As shown in FIG. 5, the highlight representation can be changed from the character area “A2” to the character area “A4”. That is, the character area “A2” is no longer displayed with highlight representation and the character area “A4” is displayed with highlight representation instead. Referring to FIG. 6, after the character area “A4” is selected as the first character area, the beginning character key “P” of the character area “A4” is displayed with highlight representation by the host 100 and the character selection cursor P can be moved into the beginning character key “P” for reminding the user. Moreover, referring to FIG. 7, the user utilizes one finger of his/her right hand to perform a slide-bottom-left action on the second touch input device TI_2, so that the input control device 108 generates and transmits the corresponding second touch operation signal S2 to the host 100 accordingly. The host 100 controls the character selection cursor P to move toward the bottom-left direction and stay on the character key “L” according to the second touch operation signal S2. Through a double-click selection operation, the character key “L” is selected as the target character key. In such a situation, the host 100 controls transmission of the character control signal corresponding to the character key “L” for realizing the character input function.

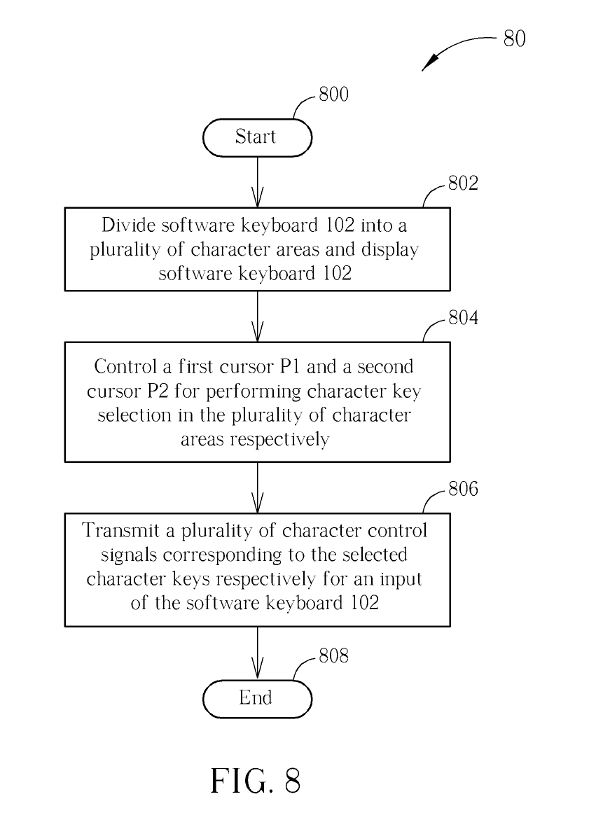

On the other hand, the invention further provides another input method by dividing software keyboard 102 into a plurality of character areas and utilizing a plurality of touch input devices for input operation simultaneously. Please refer to FIG. 8, which is a procedure 80 for the computer system 10 according to another embodiment of the invention. The procedure 80 includes, but is not limited to, the following steps:

Step 800: Start.

Step 802: Divide software keyboard 102 into a plurality of character areas and display software keyboard 102.

Step 804: Control a first cursor P1 and a second cursor P2 for performing character key selection in the plurality of character areas respectively.

Step 806: Transmit a plurality of character control signals corresponding to the selected character keys respectively for an input of the software keyboard 102.

Step 808: End.

According to the procedure 80, in Step 802, the software keyboard 102 is displayed on the display device 106 when the user has an input requirement. The host 100 can divide all character keys of the software keyboard 102 into a plurality of character areas and each character area includes at least one character key. Each touch input device can control the corresponding cursor to perform character key selection in the corresponding character area. Preferably, the host 100 is capable of allowing each touch input device to control the corresponding cursor to perform character key selection in the corresponding character area after the software keyboard 102 is activated and displayed. On the other hand, for each character area, the host 100 can select one character key from the corresponding character area to act as a beginning character key of the corresponding character area. As a result, the host 100 is able to move the first cursor P1 and the second cursor P2 to the corresponding beginning character keys. Besides, the beginning character key can be selected when the software keyboard 102 is activated or during the last operation of the software keyboard 102, and this is not a limitation of the invention.

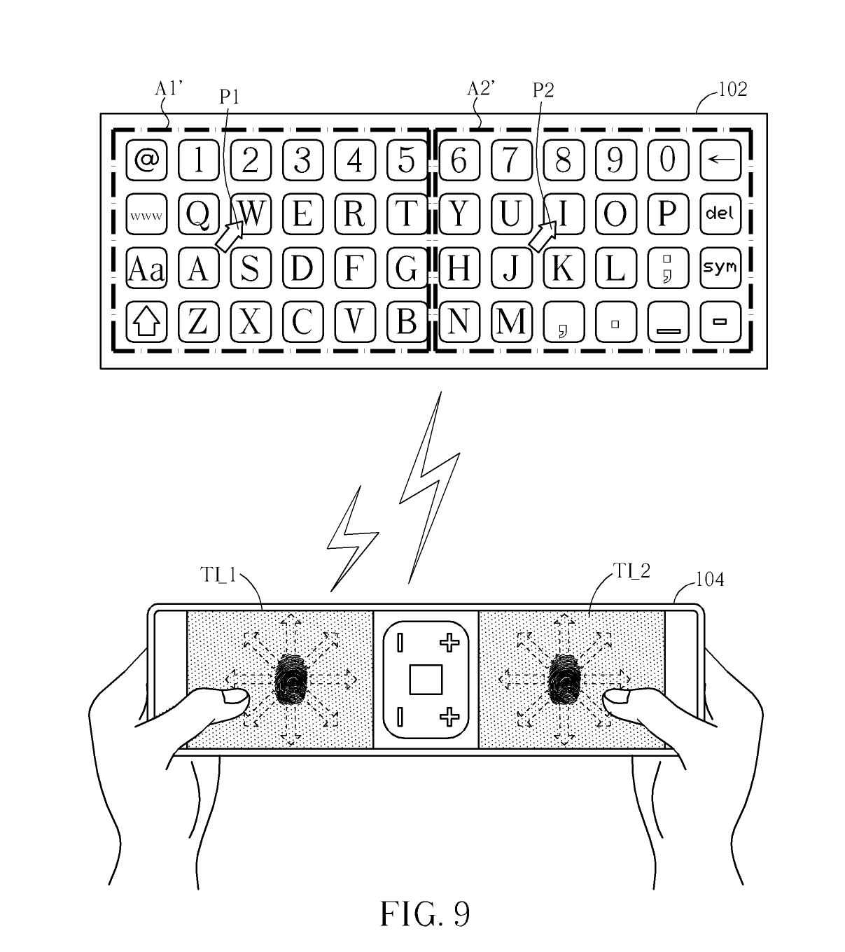

For example, please refer to FIG. 9. Suppose the first touch input device TI_1 and second touch input device TI_2 are wireless touch controllers. When the user has an input requirement while operating an application program executed in the computer system 10, and the software keyboard 102 is divided into character areas A1′ and A2′, as shown in FIG. 9, the first touch input device TI_1 is capable of controlling the first cursor P1 to perform character key selection in the character area A1′ and the second touch input device TI_2 is capable of controlling the second cursor P2 to perform character key selection in the character area A2′. In other words, as the user has an input requirement, each of the first touch input device TI_1 and second touch input device TI_2 is able to implement character key selection in the corresponding character area. As a result, the user can quickly select the desired character key without driving the cursor through the large region of the software keyboard for finding the desired character key, enhancing input operation time.

In summary, the invention can provide the user quick selection of the desired character key without driving the cursor through the large region of the software keyboard for finding the desired character key. According to the invention, the user can achieve input operations by utilizing various input touch devices to operate in a menu selection manner. In other words, the invention combines the features of a software keyboard having various character areas, cursors capable of being operated by various touch input devices, and sliding input characteristics to let the user utilize touch input devices to operate the software keyboard, so as to achieve character input quickly and conveniently. In addition, through implementation of the corresponding display mannerisms during the selection process, the invention can offer a more user-friendly and intuitive operation mode for the user, and also enhance input operation time substantially.

Those skilled in the art will readily observe that numerous modifications and alterations of the device and method may be made while retaining the teachings of the invention.

What is claimed is:

1. An input method for a software keyboard comprising:
dividing the software keyboard into a plurality of character areas and displaying the software keyboard;
generating a first touch signal;
generating a first touch operation signal according to the first touch signal;
selecting a first character area from the plurality of character areas according to the first touch operation signal;
generating a second touch signal;
generating a second operation signal according to the second touch signal;
selecting a target character key from the first character area according to the second touch operation signal; and
transmitting a character control signal corresponding to the target character key to a host for an input of the software keyboard.

2. The input method of claim 1, wherein the first touch signal is generated by operating in a first direction, and the first direction is a direction toward a neighboring character area from a start character area.

3. The input method of claim 2, wherein the start character area is one of the plurality of character areas, and the start character area is selected when the software keyboard is activated.

4. The input method of claim 2, wherein the start character area is one of the plurality of character areas, and the start character area is selected during the last operation period of the software keyboard.

5. The input method of claim 1, wherein the second touch signal is generated by operating in a second direction, and the second direction is a direction toward a neighboring character key from a beginning character key.

6. The input method of claim 5 further comprising moving a character selection cursor to a position of the beginning character key.

7. The input method of claim 6, wherein the beginning character key is one of a plurality of character keys of the first character area, and the beginning character key is selected when the first character area has been selected.

8. The input method of claim 6, wherein the beginning character key is one of a plurality of character keys of the first character area, and the beginning character key is a character key selected during the last operation period of the software keyboard.

9. An input method for a software keyboard comprising:
dividing the software keyboard into a plurality of character areas and displaying the plurality of character areas of the software keyboard;
controlling a plurality of cursors for performing character key selection in the plurality of character areas respectively; and
transmitting a plurality of character control signals corresponding to the selected character keys respectively for an input of the software keyboard.

10. The input method of claim 9, wherein the plurality of cursors move into positions of a plurality of beginning character keys when the software keyboard is activated.

11. The input method of claim 10, wherein each of the plurality of beginning character keys is a central character key of the corresponding character area of the plurality of character areas.

12. The input method of claim 10, wherein each of the plurality of beginning character keys is selected in the corresponding character area of the plurality of character areas during the last operation period of the software keyboard.

13. The input method of claim 9 comprising outputting the plurality of character control signals corresponding to a plurality of target character keys selected by a plurality of touch input devices.

14. An input device for a software keyboard, comprising:
a plurality of touch input devices for generating a plurality of touch signals corresponding to user operations; and
an input control device for generating a plurality of touch operation signals according to the plurality of touch signals;
wherein a plurality of character control signals corresponding to the plurality of touch operation signals is utilized as an input of the software keyboard.

15. The input device of claim 14, wherein the plurality of touch input devices controls a plurality of cursors to respectively select a target character key from the corresponding character area, and generate the corresponding character control signal according to the target character key.

16. The input device of claim 14, wherein one of the plurality of touch input devices chooses a first character area, another touch input device controls a character selection cursor to select a target character key in the first character area, and the character control signal corresponding to the target character key is generated accordingly.

17. The input device of claim 15, wherein the plurality of cursors move into positions of a plurality of beginning character keys when the software keyboard is activated.

18. The input device of claim 16, wherein the character selection key is moved to a position of a beginning character key.

19. The input device of claim 17, wherein each of the beginning character keys is a central character key of the corresponding character area of the plurality of character areas.

20. The input device of claim 19, wherein each of the beginning character keys is selected in the corresponding character area of the plurality of character areas during the last operation period of the software keyboard.

21. The input device of claim 18, wherein each of the beginning character keys is a central character key of the corresponding character area of the plurality of character areas.

22. The input device of claim 21, wherein each of the beginning character keys is selected in the corresponding character area of the plurality of character areas during the last operation period of the software keyboard.

23. A computer system, comprising:
a display device for displaying a software keyboard, the display device comprising a host for dividing the software keyboard into a plurality of character areas;
a plurality of touch input devices for generating a plurality of touch signals corresponding to user operations; and
an input control device for generating a plurality of touch operation signals according to the plurality of touch signals;
wherein the host selects at least one character control signal corresponding to the plurality of touch operation signals as an input of the software keyboard.

24. The computer system of claim 23, wherein the plurality of touch input devices controls the plurality of cursors to respectively select a plurality of character keys in a plurality of character areas.

25. The computer system of claim 23, wherein one of the plurality of touch input devices chooses a first character area, another touch input device controls a character selection cursor to select a target character key in the first character area, and the character control signal corresponding to the target character key is generated accordingly.

26. The computer system of claim 24, wherein the plurality of cursors move into positions of a plurality of beginning character keys when the software keyboard is activated.

27. The computer system of claim 25, wherein the character selection key is moved to a position of a beginning character key when the software keyboard is activated.

28. The computer system of claim 26, wherein each of the beginning character keys is a central character key of the corresponding character area of the plurality of character areas.

29. The computer system of claim 28, wherein each of the beginning character keys is selected in the corresponding character area of the plurality of character areas during the last operation period of the software keyboard.

30. The computer system of claim 27, wherein each of the beginning character keys is a central character key of the corresponding character area of the plurality of character areas.

31. The computer system of claim 30, wherein each of the beginning character keys is selected in the corresponding character area of the plurality of character areas during the last operation period of the software keyboard.
